(19) United States
(12) Patent Application Publication
(10) Pub. No.: US 2015/0374163 A1
(43) Pub. Date: Dec. 31, 2015

(54) METHOD OF OPERATING A DOMESTIC COOKING HOB, CONTROL UNIT AND DOMESTIC APPLIANCE

(71) Applicant: ELECTROLUX APPLIANCES AKTIEBOLAG, Stockholm (SE)

(72) Inventors: Fabio Spanò, Forli (IT); Nicola Guardigli, Forli (IT)

(73) Assignee: Electrolux Appliances Aktiebolag, Stockholm (SE)

(21) Appl. No.: 14/768,552

(22) PCT Filed: Feb. 7, 2014
(86) PCT No.: PCT/EP2014/052387

§ 371 Date: Aug. 18, 2015

(30) Foreign Application Priority Data
Mar. 8, 2013 (EP) 13158358.5

(51) Int. Cl. A47J 27/62

(52) U.S. Cl. CPC A47J 27/62

(57) ABSTRACT

A method of operating a domestic cooking hob (1, 3), wherein the cooking hob (1, 3) includes a user control interface (4) adapted to inputting user control information for controlling operation of the cooking hob (1, 3). The cooking hob (1, 3) is operable in a safety locked operational mode. In the safety locked mode, the cooking hob (1, 3) triggers a safety action in case that a person tries to operate the control interface (4) without unlocking the cooking hob (1, 3) or a person comes closer to the cooking hob (1, 3) than a preset distance without unlocking the cooking hob (1, 3).

The present application is directed to a method of operating a domestic cooking hob, a control unit for controlling the operation of a domestic cooking hob and to a corresponding domestic appliance.

Domestic cooking hobs are widely known and implemented as inductive heating hobs, resistance heating hobs and gas heating hobs. In particular with respect to children, elderly persons and handicapped persons it would in certain instances be desirable to have improved safety functions, in particular intended for avoiding injuries and serious burns.

Document FR 2869398 A1 describes a cooking hob with a function in which a possible user has to authorize himself for operating the hob, i.e. for unlocking the hob, by inputting biometric identification data. Unlocking the hob may occur if the inputted biometric identification data are known to the hob. A similar system is described in WO 2005/106335.

EP 0 727 616 A1 describes a cooking hob with a childproof lock. The hob may be taken out of the childproof lock mode by simultaneously opening and closing tabs briefly or via a separate push button.

Document DE 200 03 307 U1 describes a household appliance with a remote control by which an authorized user can shut off the appliance or gets a warning in case that unauthorized use of the appliance is detected.

Documents EP 2 037 178 A1, DE 102 56 464 A1 and DE 20 2008 000 665 U1 are directed to providing cooking hobs or household appliances with proximity sensors to detect persons in front of the appliances. The information whether a person is present or not, or additional information such as the calculated size of a detected person, may be used to control the appliance.

It is an object of the invention to provide a method of operating a domestic cooking hob, a respective control unit and domestic appliance with improved safety functions, in particular directed to avoid injuries for children, elderly persons and handicapped persons.

This object in particular is obtained by claims 1, 12 and 13. Preferred embodiments in particular result from respective dependent claims.

According to claim 1, a method of operating a domestic cooking hob or cooking appliance is provided. A domestic cooking hob in particular shall comprise cooktops with a single or several heating points or heating areas, respectively adapted to heat cookware and the like. In general, operating a cooking hob comprises controlling power supply to the cooking hob. Power supplied to the cooking hob or cooking point(s) may be one of gas and electric power.

The cooking hob to be operated with the proposed method comprises a user control interface. The user control interface is adapted to inputting user control information for controlling operation of the cooking hob. In particular, the user control unit may comprise a touch sensitive surface or display adapted to adjust or set operational parameters of the cooking hob. Touch sensitive shall mean, that the action of touching, i.e. of getting in contact, is sufficient to generate some type of input signal. The user control interface may be adapted to input operational parameters, to activate or deactivate the cooking hob and the like.

According to the proposed method, the cooking hob is operable in a safety locked operational mode. In this safety locked operational mode, the cooking hob triggers a safety action in case of certain alert conditions. In other words, if the cooking hob, e.g. a sensor unit or controller thereof, detects an alert condition, i.e. a safety critical condition, a safety action is triggered, executed or activated. The alert condition may be a safety critical condition in which the operating cooking hob may cause harm to non-involved persons, such as children and the like.

According to the proposed method, an alert condition is at least one of the following conditions:
a person tries to operate the control interface without unlocking the cooking hob and
a person comes closer to the cooking hob than a preset distance without unlocking the cooking hob.

In other words, if the cooking hob is in the safety locked state, the operation of the control interface or the mere presence of a person in a preset distance from the cooking hob leads to the safety action, unless the cooking hob is unlocked, i.e. transferred from the safety locked operational mode to the ordinary operational mode, in which the cooking hob is freely operable. Unlocking options will be described further below.

With the proposed method, at least two types of dangerous or risky situations may be avoided.

One type of such situations is when non-involved persons, such as children, obtain unintended access to the control interface of the operating cooking appliance and randomly and arbitrarily try to work on the user control interface. In particular in these situations, any amendments to power levels and other operational parameters shall be avoided. Therefore, it is of advantage that the safety action at least locks the user control interface to prevent any changes in the operational parameters. If the cooking hob is in the off-state, blocking the activation of the cooking hob is of advantage, whereas if the cooking hob is in an activated operational state, it may be of advantage to block any change or increase of cooking power level, for example. In some cases it may even be desirable to shut down the cooking hob in case of an alert condition.

Another type of such situations is when non-involved persons, such as children, elderly and/or handicapped persons come close, i.e. closer than a predetermined distance, to the activated cooking hob. In particular under these conditions, it may in some cases be of advantage to shut down, or even immediately stop operation of the cooking hob. Stopping or shutting down the cooking hob at least reduces power transfer to the cooking point or cookware. In case of gas cooking hobs, shutting off of the gas burner in general will remove open flames and interrupt gas supply, which are considered as two serious safety threads.

As can be seen, the proposed method is effective in providing satisfactory safety functions and functionalities to cooking hobs, in particular to gas cooking hobs.

In an embodiment of the method, unlocking, i.e. an unlocking action, requires entering a predefined input on or to the control interface. It shall be noted, that if a locking functionality is provided, the action of transferring the cooking hob to the safety locked operational mode can similarly require entering a predefined input on or to the control interface. The predefined input may be comparatively specific such that ordinary operations or actions of non-involved persons on the user control interface will generally not lead to unlocking the cooking hob. The predefined input may for example require to touch or even to press a certain button or area of the user control interface, in particular for given minimal time durations and the like. Anyhow, specific predefined inputs may be used to avoid unintentional unlocking by arbitrary actions of non-involved persons.

In a further embodiment, the predefined, in particular specific, input comprises operating a predefined control section, in particular keypad, of the control surface. As already mentioned, the predefined control section may be one which in general will not be operated accordingly by non-involved persons. As an option, the predefined input may comprise the operation or input of a control sequence, in particular a given control sequence on the control interface. In this case, unlocking is comparable to inputting a pin or ID on the control interface, wherein the input will transfer the cooking hob from the locked to the unlocked mode. Note that respective possibilities can also be implemented for transferring the cooking hob from the unlocked to the locked mode.

In a variant of the method as set out before, the predefined control section is selected from at least one of a safety-lock key or keypad, safety-lock knob or safety-lock control element and an on/off key, keypad, knob or control element. This in particular means, that unlocking, or also locking, may be obtained by touching, or even pressing, a special keypad, and the like, specifically provided and adapted for unlocking, or locking, the cooking hob, in particular user control interface. If the respective keypad, and similar, is not operated or activated, the safety action will be carried out.

It shall be noted, that providing respective unlocking options and predefined control sections and the like enables an involved, authorized person, such as for example a person having started or switched on the cooking hob, to avoid the execution of the safety function by respectively unlocking the cooking hob or user control interface. Unlocking the cooking hob or user control interface may bring them back to ordinary and normal operation in which the user is allowed to set, adapt and/or change operational parameters or modes via the user control interface.

In a variant of the method it may be provided that unlocking, and in particular also locking, requires operating the safety-lock key, keypad, knob, button, control element and the like, for a minimum time duration. In general, involved, i.e. authorized, persons, such as qualified users, are aware of this time duration and will readily activate the safety-lock key within the preset time duration in order to prevent execution of the safety action, and thus return to the unlocked state.

It shall be noted, that upon unlocking the cooking hob and/or user control interface, in particular upon timely executing the unlocking action, the execution of the safety action generally will not carried out.

In a further variant of the method, locking, and in particular unlocking, requires operating the safety-lock key within a preset time interval. In other words, if the unlocking key is not operated within the preset time interval, the safety action will be triggered. In general, involved persons, such as qualified users will be aware of the preset time interval and timely operate the unlocking key in order to prevent execution of the safety action.

Using a preset time interval in which the unlocking action has to be performed in order to avoid the safety action, in particular is advantageous if the proximity of the cooking hob is monitored for the presence of persons and is used as an indication of alert conditions. In more details, if the presence of a person, e.g. a non-involved or unauthorized person like a child, in the proximity of the cooking hob is detected and the person fails or is not able to unlock the cooking hob or user control interface, the safety action will be carried out. If the person is aware of the time interval, he will of course be able to timely execute the unlock action and return the cooking hob and/or user control interface to the unlocked, i.e. ordinary operational mode.

Here it shall be mentioned, that the starting point of the time interval may be a point of time in which a respective alert condition is detected, in particular in which the unauthorized presence of a person in the proximity of the cooking hob is detected, determined or recognized.

In embodiments it is provided, that unlocking of the cooking hob is carried out or obtained by recognizing an authorized user via biometrical information or identifications. Such recognition may be conducted automatically. Biometrical recognition of the user may be obtained by at least one of fingerprint recognition, eye recognition, face recognition, or other biometrical, user specific parameters. Respective biometrical sensors may be provided with the cooking hob or appliance, in particular coupled with respective control devices configured for carrying out locking and unlocking actions and/or for screening locking and unlocking requirements in particular related to biometrical data.

In an embodiment of the present method, it is provided that the safety-locked operational mode is automatically established after a preset idle time of the user control interface. This may be advantageous in situations in which the activated cooking hob is left alone for a certain period of time. In this embodiment, the safety-locked state may be activated if any user actions are detected or registered for a certain time period. A respective idle time may be selectable by the user, in particular via the user control interface.

In an embodiment it is provided, that the safety action comprises at least one of shutting down the cooking hob, issuing a visual warning and issuing an acoustic warning. Visual and acoustic warnings may alert the non-involved person in order to desist from acting on or approaching the cooking hob. In addition or in the alternative, visual and acoustic warnings may alert the non-conventional use of the cooking hob. Shutting down or off the cooking hob is a measure with the aim of preventing severe injuries or damages to the non-involved person and/or the environment.

In a yet further embodiment, the cooking hob comprises a proximity sensor which at least in the safety-locked operational mode at least partially monitors the proximity of the cooking appliance. The proximity sensor in particular is adapted to detect alert conditions in which a non-involved person comes closer to the cooking hob than a preset or allowed distance. The signal of the distance sensor in particular may be used for generating an alert signal. In other words, an alert signal may be generated on the basis of or by using sensor signals of the distance sensor. In case that a person, in particular a non-involved person, or other objects, or even animals or pets, come/s closer than the preset distance. It shall be stressed, that environment observation by the proximity sensor may not be restricted to persons, but also may involve objects, animals, in particular pets and the like. If it is determined that an object, in particular person, is closer than the preset distance, it is further checked if an unlocking action is performed, preferably within a certain time interval. If no unlocking action can be observed or determined, the safety action will be performed.

As can be seen, the proposed method is effective in providing safe operation of the cooking hob.

According to claim 12, a control unit adapted to control the operation of a domestic cooking hob is provided. The control unit comprises a controller, in particular an electronic controller, such as a microcontroller, which is configured to execute a method as described further above, in particular including any embodiment thereof. As to advantages and advantageous effects, reference is made to the description above.

According to claim 13, a domestic appliance is provided, in particular a cooking oven based on induction heating, resistance heating and/or gas heating. The domestic appliance comprises a cooking hob and a user control interface adapted for inputting user control commands or information for controlling operation of the cooking hob. The user control interface may be implemented as set out in the description as set out further above, which applies mutatis mutandis.

The domestic appliance further comprises a controller which is configured to execute a method as described further above, in particular including any embodiments thereof. As to advantages and advantageous effects, reference is made to the description above and further above.

In an embodiment, the domestic appliance comprises a proximity sensor unit with at least one proximity sensor. The proximity sensor may be implemented in a cover, in particular in a front cover of and/or a cover around the cooking hob. Further, the proximity sensor may be adapted to monitor, in particular from any direction, a preset or defined proximity, in particular, however, a front and/or upper proximity, of at least the cooking hob. In the embodiment, it is provided that the controller is adapted to use sensor signals of the proximity sensor for operating the cooking hob. In particular, operating the cooking hob in dependence of the sensor signals may comprise triggering a safety action in case that an object, in particular person, is observed in a distance to the cooking hob closer than the preset distance, provided that any unlocking action is duly performed.

In a yet further embodiment, the domestic appliance further comprises at least one of a graphic display adapted to display a visual warning in case of the occurrence of an alert condition, and/or sound generator adapted to generate an acoustic warning in case of the occurrence of an alert condition. The graphic display may be implemented with the user control interface, in particular in form of a touch-sensitive display. The graphic display and sound generator, in particular a loudspeaker, may be connected to the controller and adapted to be controlled by the controller.

For further advantages and advantageous effects of the domestic appliance, in particular a gas cooking appliance, such as a gas cooktop, reference is made to the description above relating to the proposed method and control unit.

Embodiments of the invention will now be described in connection with the annexed figures, in which

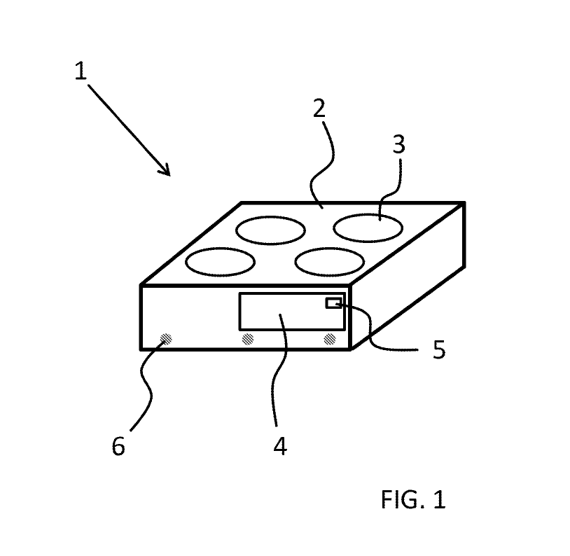

FIG. 1 shows a schematic representation of a domestic cooking appliance;

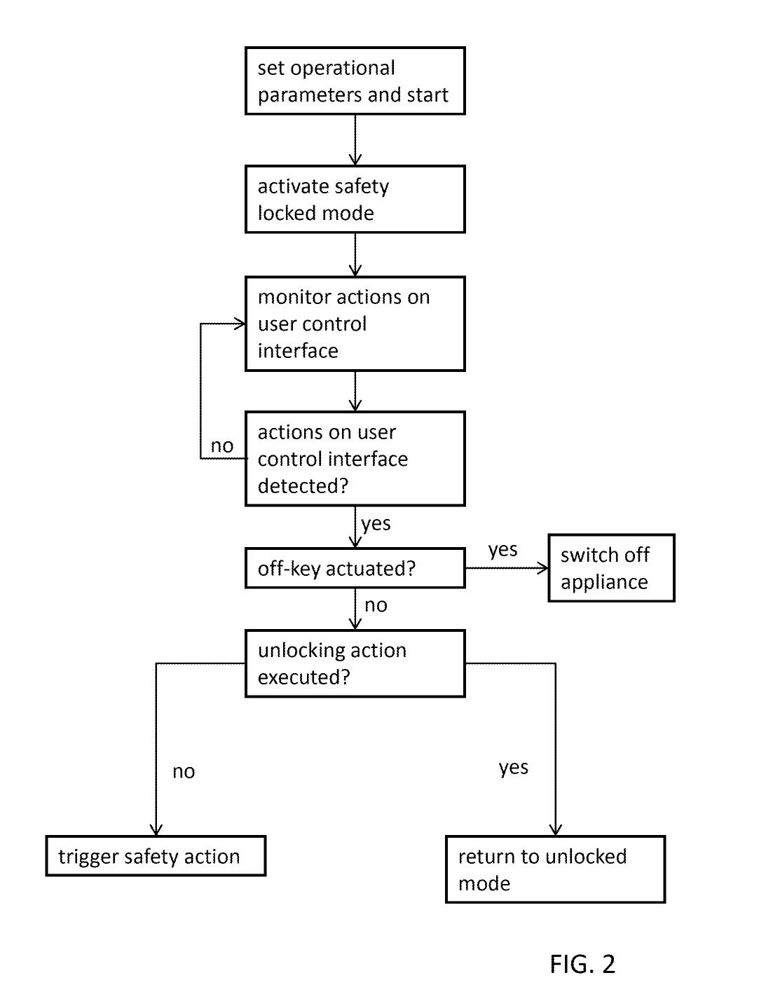

FIG. 2 shows a block diagram of a first operational sequence; and

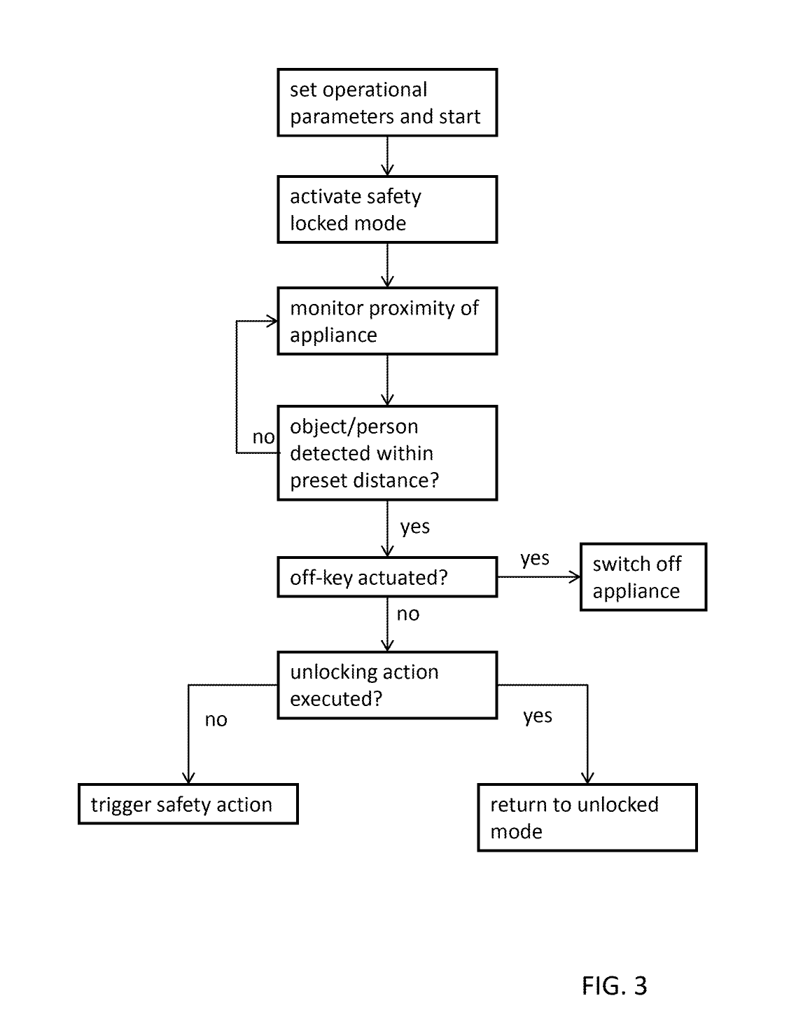

FIG. 3 shows a block diagram of a second operational sequence.

The invention will now be described in connection with selected embodiments of a domestic cooking appliance, which in particular may be a gas cooking appliance, wherein the selected embodiments shall not be construed as limiting the scope of the invention. Rather, the invention can be applied and used in connection with similar household cooking appliances mentioned already further above.

FIG. 1 shows a schematic representation of a domestic cooking appliance 1. The cooking appliance comprises a cooktop 2 with several, in the present case four, burners 3.

The appliance 1 further comprises a user control interface 4 which is adapted and provided for allowing a user to input and/or set operational parameters of the cooktop, in particular of single cooking points or burners 3. The user control interface 4 in particular may be a touch-sensitive user interface, in particular a touch-sensitive graphical user interface.

The appliance 1 further comprises 1 a controller (not shown) adapted to operate the burners 3 according to user settings inputted and/or set via the user control interface 4.

The user control interface in particular comprises a safety-lock key and/or on/off key 5. The key or keys may be implemented as predefined regions on the touch-sensitive display.

The appliance further comprises several, proximity sensors 6. The proximity sensors 6 in the present case are implemented at a front face of the cooking hob, preferably below or integrated in a front cover of the appliance 1. Note that the proximity sensors 6 may be varied in number and arrangement, in particular as far as it is possible to detect objects, in particular persons in close proximity to the burners 3. In particular, the proximity sensors are adapted to sense or detect an approaching object or person and/or the presence of an object or person in a distance lower than a preset distance from the appliance 1, in particular a preset distance from the front face of the appliance 1.

The function of respective elements will be described and will become apparent in connection with FIG. 2 and FIG. 3, respectively showing block diagrams of a first to third operational sequence of the appliance 1.

FIG. 2 shows a block diagram of a first operational sequence. In a first step, a user starts to set operational parameters of the appliance via the user control interface 4, and thereafter, the user starts operation of one or more respective burners 3.

After starting operation of the burner 3, the burner or cooking appliance may automatically switch to the safety locked operational mode. In particular switching to the safety locked operational mode may automatically be carried out after a certain time interval. In the alternative, the safety locked operational mode may be activated by the user. Activation by the user may for example comprise pressing or touching a respective key 5 or keypad for a preset time duration.

After transferring the appliance 1 to the safety-locked operational mode, the controller continuously monitors the user control interface, in particular if any actions, in particular touching actions, are performed on the user control interface.

As long as the controller does not detect any new actions on the user interface, the controller continues monitoring of the user control interface. In case that an action on the user interface is detected, the controller will check if the action of the user interface is pressing the off-key of the appliance. In case that the off-key is pressed, actuated or touched, the controller will turn off, in particular shut down, the appliance. Here it shall be mentioned that it is of advantage to maintain the function of the off-key even in the locked mode. Actuation of the off-key may also be checked or monitored within or at other steps or time-points of the method.

If the off-key is not pressed, the controller monitors whether an unlocking action is executed or not and/or an unlocking condition is obtained. The unlocking action in the present case in particular may comprise touching the key 5 for a preset time duration, which may for example amount about 0.5 s to 1.0 s or ever more. However, other unlocking events, in particular conditions, such as unlocking a registered or authorized user via biometrical data, in particular fingerprint recognition, eye recognition, face recognition and the like, may be used.

Fingerprints, eye and/or face information, in general biometrical information on authorized users may be stored on a memory of the appliance, in particular controller to be available for comparison.

If the controller detects an unlocking action within a certain period of time, such for example 1 s, the locking state is left, and the appliance, in particular burner 3, is returned to the unlocked mode, i.e. to the ordinary operational mode. Adequately performing the unlocking action in general will and can be performed by the involved, authorized user such that he can use the cooking appliance as usual.

However, non-involved, i.e. unauthorized, persons, such as little children, elderly persons or handicapped persons, are not able and do not know how to unlock the household appliance 1. Therefore, the unlocking action, i.e. pressing the key 5, in general will not be performed within or for a certain period of time, and therefore the cooking appliance 1 will not return to the unlocked state. Instead, the controller 1 may execute or trigger a safety action in order to prevent injuries and burns.

The safety action may for example be an acoustic warning, a graphic warning or may in particular cause at least the burner 3, if required the whole cooking appliance, to shut down. In particular these safety actions may be effective in preventing undesirable situations for non-involved persons, such as children, and in particular may be effective in preventing injuries and other damages.

FIG. 3 shows a block diagram of a second operational sequence. It shall be noted that the operational sequences according to FIG. 2 and FIG. 3 can be combined to obtain an even more effective safety function.

With the second operational sequence, the burner appliance 1, in particular the burner 3 is started up and locked in a similar or identic manner as in FIG. 2. In contrast to the first operational sequence, the controller now monitors by the aid of the proximity sensors 6, in particular by using sensor signals of the proximity sensors 6, the proximity or surroundings of the appliance 1. As long as no object or person is detected by the proximity sensors 6 operation of the appliance 1, in particular respective burner(s) 3 is continued and the monitoring action is continuously carried out.

In case that the presence or approach of an object or person is detected, and it is determined that the object or person is within a preset or certain distance from the appliance 1 or burner 3, the controller checks if the off-key is pressed or actuated. If the off-key is actuated, the appliance is shut off or down. Note that actuation of the off-key may be checked or monitored within or at other steps or time-points of the method. Further reference is made to the description above related to activation of the off-key.

If the off-key is not pressed, the controller checks if an unlocking action is performed within a certain, in particular preset time duration. The time duration may for example amount about 1 s.

If an unlocking action is detected, the controller will transfer the appliance to the unlocked state, i.e. in the ordinary operational state. If, however, any unlocking action is detected within the time duration, the controller will execute or trigger the safety action. The safety action may be identical to that described in connection with the first operational sequence. Reference is therefore made to the description above.

As can be seen, in the first and second operational sequences, it is possible to issue or trigger a safety action in case that a non-involved, unaware and/or unsuspecting person tries to act on or operate on the user control interface or comes too close to the operating appliance 1 or burner 3. Via the safety action, dangerous situations, harms and damages can be greatly prevented. However, for the involved and knowing, authorized user or operator, it is comparatively easy to transfer the appliance from the safety-locked operational mode to normal mode operation in simply executing a predefined unlocking action. It shall be noted, that it may be provided that the user can select the type and extent of the unlocking action. In other cases, the unlocking action may by fixed by the manufacturer.

### LIST OF REFERENCE NUMERALS

1 cooking appliance
2 cooktop
3 burner
4 user control interface
5 key
6 proximity sensor

What is claimed is:

1. Method of operating a domestic cooking hob (1, 3), wherein the cooking hob (1, 3) comprises a user control interface (4) adapted to inputting user control information for controlling operation of the cooking hob (1, 3), wherein the cooking hob (1, 3) is operable in a safety locked operational mode in which the cooking hob (1, 3) triggers a safety action in case of at least one of the following alert conditions:
a person tries to operate the control interface (4) without unlocking the cooking hob (1, 3) and
a person comes closer to the cooking hob (1, 3) than a preset distance without unlocking the cooking hob (1, 3).

2. Method according to claim 1, wherein unlocking requires entering a predefined input on the control interface (4).

3. Method according to claim 2, wherein the predefined input comprises operating a predefined control section, in particular key (5), or control sequence on the control interface (4).

4. Method according to claim 3, wherein the predefined control section is selected from at least one of a safety-lock key (5) and an on/off key.

5. Method according to claim 4, wherein unlocking requires operating the safety-lock key (5) or on/off key for a preset minimum time duration.

6. Method according to claim 1, wherein unlocking of the cooking hob is carried out by recognizing an authorized user via biometrical information, in particular via a fingerprint recognition, an eye recognition and/or a face recognition.

7. Method according to claim 1, wherein the safety-locked operational mode is automatically established after a preset idle time of the user control interface (4).

8. Method according to claim 1, wherein the safety action comprises at least one of shutting down the cooking hob (1, 3), issuing a visual warning and/or issuing an acoustic warning.

9. Method according to claim 1, wherein issuing the visual warning comprises displaying a warning on a graphic display (4).

10. Method according to claim 1, wherein the cooking hob (1, 3) comprises a proximity sensor (6) which at least in the safety-locked operational mode at least partially monitors the proximity of the cooking hob (1, 3), wherein preferably an alert signal is generated based on sensor signals of the proximity sensor (6) in case that a person comes closer than the preset distance.

11. Control unit adapted to control the operation of a domestic cooking hob (1, 3), wherein the control unit comprises a controller configured to execute a method according to claim 1.

12. Domestic appliance (1) comprising a cooking hob (3), a user control interface (4) adapted for inputting user control commands for controlling operation of the cooking hob (3), and a controller configured to execute a method of operating the domestic appliance (1) according to claim 1.

13. Domestic appliance (1) according to claim 12, further comprising a proximity sensor unit with at least one proximity sensor (6) adapted to monitor a preset proximity of at least the cooking hob (3), wherein the controller is adapted to use sensor signals of the proximity sensor (6) for operating the cooking hob (3).

14. Domestic appliance (1) according to claim 12, comprising at least one of a graphic display (4) adapted to display a visual warning in case of the occurrence of an alert condition, and sound generator adapted to generate an acoustic warning in case of the occurrence of an alert condition.
